(19) United States
(12) Patent Application Publication
(10) Pub. No.: US 2010/0175187 A1
(43) Pub. Date: Jul. 15, 2010

(54) MATTRESS FOUNDATION AND KIT FOR SAME

(75) Inventor: Robert A. Hall, Plantersville, MS (US)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(73) Assignee: ASHLEY FURNITURE INDUSTRIES, INC., Arcadia, WI (US)

(21) Appl. No.: 12/684,736

(22) Filed: Jan. 8, 2010

Related U.S. Application Data
(60) Provisional application No. 61/143,390, filed on Jan. 8, 2009.

(51) Int. Cl. A47C 19/00; B23P 11/00; B23P 17/00

(52) U.S. Cl. 5/400; 29/428; 29/525.01

(57) ABSTRACT

A mattress foundation is provided that may be compactly and thus inexpensively shipped in kit form and easily assembled into a full sized foundation for use under a mattress by the user. The foundation is light weight and comprises a plurality of rails, end caps, fasteners, interlacing rigid deck panels, and a cover. A top “decking is applied with a plurality of panels that form junctures that present a snaking configuration. Removable fasteners connect the decking to the framework and secure the framework together for easy disassembly. The cover is sheet material with a fully expanded shape conforming to the shape of the frame of the foundation utilizes zippers, Velcro and/or other fasteners to enclose the framework and decking.

### RELATED APPLICATIONS

This application claims the benefit of U.S. Provisional Application No. 61/143,390, filed Jan. 8, 2009, entitled MATTRESS FOUNDATION AND KIT FOR SAME, said application hereby fully incorporated herein by reference.

### BACKGROUND OF THE INVENTION

Conventional mattresses typically use a foundations to support the mattress and to position the mattress at a convenient expected height. Such foundations may be of the configuration known as box springs and are often supported by bed frames at the foundations outer perimeter. Conventional box springs are as bulky as the mattresses and thus are awkward to move, difficult and expensive to transport.

Foundations that may be assembled at point of use are known and may be referred to as knock-down foundations. See, for example, U.S. Pat. Nos. 5,469,589; 5,564,140; 6,382,397; and 7,003,822.

All foundations obviously need to be adequate to support the weight of the mattress and as many people or pets that may end up on the finished bed. When such foundations are assembled on site they may be subsequently moved or further shipped. Such shipment may be with the foundation in an assembled state or the user may choose to disassemble the foundation before such move. The foundation thus needs to be structurally secure enough when assembled to withstand the forces associated with the move without falling apart or being damaged. Moreover, disassembly of the foundation, and subsequent reassembly must still be possible without great effort. Moreover, such reassembly would ideally be simple and intuitive such that if instructions are misplaced, assembly is still relatively easily accomplished.

Generally, it would be beneficial for such foundations to be more easily assembled on-site, with fewer components and less efforts than presently required by the prior art knock down foundations. Moreover, to the extent that lesser priced components may be selectively utilized in the foundation, sales margins can be increased while providing great value to the customer. Additionally, it would be advantageous to reduce the shipping volume and weight of current knock-down foundations.

### SUMMARY OF THE INVENTION

An embodiment of a mattress foundation may be compactly and thus inexpensively shipped in kit form and easily assembled into a full sized foundation for use under a mattress by the user. The foundation is very compact in the kit form and comprises a pair of end rails or end caps, a plurality of transverse rails, deck panels, and a cover. The transverse rails are formed of wood, having a pair of horizontal chord members with web pieces to form a rectangular truss-like structure. Four or about four of the rails aligned side by side and spaced have end caps are attached thereto. A top “decking” comprising mattress support panels lay adjacent one another and form abutting junctures. Said panels may be easily secured to the rails with fasteners such as polymer push pins. The junctures of the plurality of panels present an interlacing or a snaking configuration above each rail. Floor sections may be attached with push-in polymer fasteners. The cover is sheet material with a fully expanded shape conforming to the shape of the frame of the foundation and may utilize zippers, hook and loop material and other fasteners for closing the cover on the frame.

A feature and advantage is an inexpensive to manufacture foundation is provided that is simple to assemble and that provides a robust base for a mattress.

A feature and advantage of embodiments of the invention is that the connecting deck panel's edge portions are interlaced where the panel edges confront one another forming the panel junctures. The interlacing is provided by a serpentine or zigzag shape of the respective confronting edges. The interlacing allows the supporting rail to be less wide to receive the fasteners and still provide adequate support for the both edge portions of the panels. The transverse rails may be formed of 1″×2″ nominal lumber which provides surprising strength and light weight.

A feature and advantage of embodiments of the invention is a knockdown foundation whereby the deck panels fasten with polymer push pins to secure the deck panels to rails. The push pins may be inserted in predrilled holes in the rails and through apertures in the deck panels.

A feature and advantage of embodiments of the invention is a knockdown foundation with rails and panel edges from adjacent panels forming a serpentine juncture on the top surfaces of a rail and wherein the panel edges maintain their position over said rail the entire length of the rail and wherein each panel is attached to said rail at least two points.

A feature and advantage of embodiments of the invention is a knockdown foundation with a serpentine junctures between adjacent deck panels.

A feature and advantage of embodiments of the invention is a knockdown foundation that utilizes wood components that are inexpensive and structurally strong.

A feature and advantage of embodiments of the invention is a knockdown foundation to be more easily assembled on-site, with fewer components and less efforts than presently required. Moreover, assembly is intuitive and simple. In certain embodiments only two different fasteners to be utilized, a steel threaded member to connect the transverse rails and end rails, and a plastic push pin to connect the deck panels to the rails.

A feature and advantage of embodiments of the invention is a knockdown foundation that has a serpentine juncture entirely or substantially on the top surface of a rail. The serpentine juncture allows the fastening of both edge portions to the rail it a plurality of locations arranged in a line. The serpentine juncture eliminates any unsupported edges of the panels and thus allows for thinner panels to provide essentially the same load carrying capacity.

### DESCRIPTION OF THE FIGURES

FIG. 1 is a perspective view of a kit containing the components in a cardboard box for constructing a foundation according to the invention herein.

FIG. 2 is a perspective view of the components removed from their box and inverted from the orientation of FIG. 1.

FIG. 3 is a perspective view of the kit including the foundation pack list and items as packed.

FIG. 4 is a perspective exploded view of assembly details of the foundation illustrating an intermediate transverse rail, an end rail, decking, and fasteners in accord with the invention.

FIG. 5 is a perspective view of the rails assembled between the end rails forming the framework in accord with the invention.

FIG. 6 is a perspective view of the decking on the framework illustrating the serpentine junctures in accord with the invention.

FIG. 7 is a perspective view of the cover prior and framework with decking prior to the cover receiving the frame inside the cover.

FIG. 8 is a perspective view of the frame inside the cover with the flap open. FIG. 9 is a perspective view of a corner of the foundation in accord with the invention.

FIG. 10 is a perspective view of the covered frame.

FIG. 11 is a series of steps for assembling a knock down foundation in accord with the invention.

### DETAILED DESCRIPTION

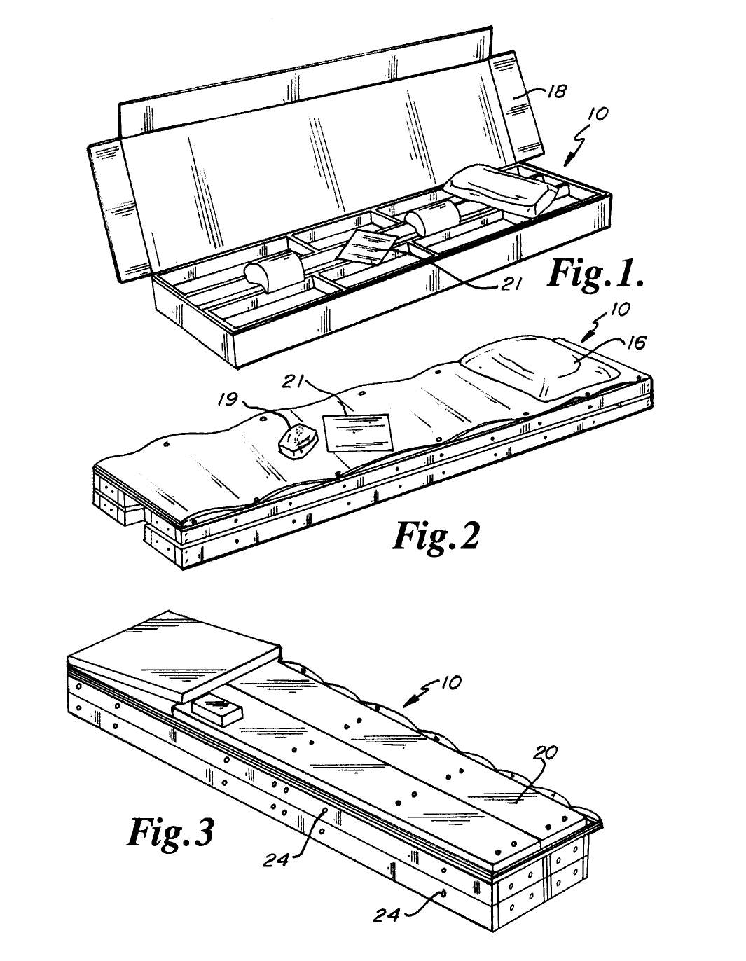

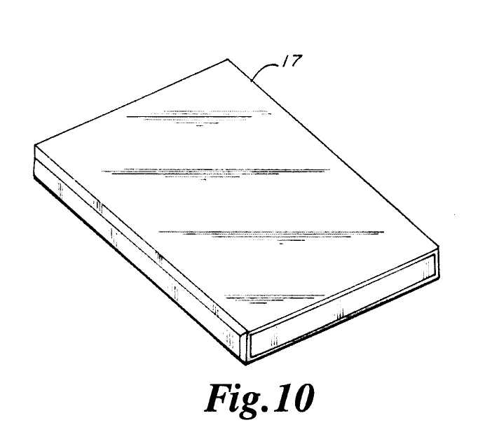

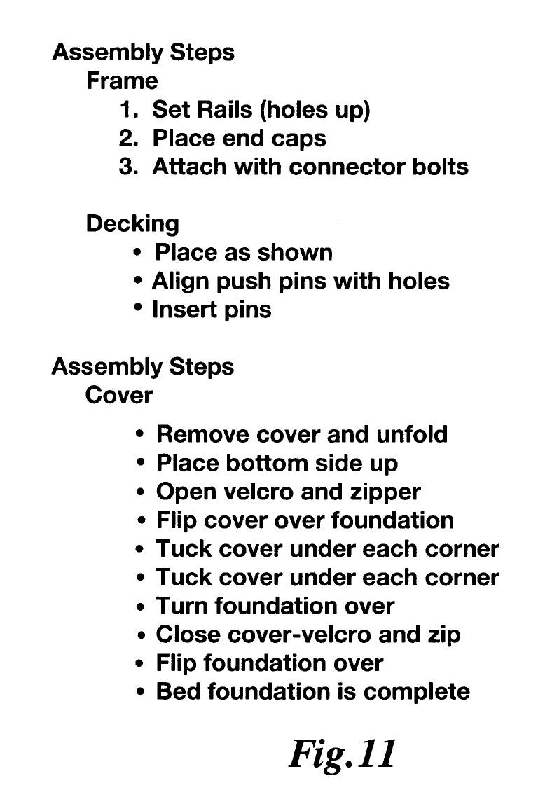

Referring to FIGS. 1, 2, and 3, a kit 10 for knock down foundation is illustrated. FIGS. 5, 6, 7, and 8 illustrate the principal components of the knock down foundation comprising a framework 12, decking 14, and a cover 16. An assembled knock down foundation 17 is illustrated in FIGS. 10. The kit 10 may be provided in a cardboard box 18, as illustrated in FIGS. 1 and 2, and inexpensively shipped due to its compact configuration and minimal weight. Simple hardware 19 such as screws and polymer push pins may be included. Easy assembly instructions 21, essentially as provided by the steps as illustrated in FIG. 11 may be utilized in the consumer assembly of the frame.

Referring to FIGS. 3, 4, and 5 the rails are illustrated and comprise end rails 20 also termed end caps, and transverse rails 24 including intermediate transverse rails 26. There may suitably be two intermediate transverse rails and two perimeter. The transverse rails are preferably configured as trusses and may appropriately utilize wood truss technology in assembly and design. Such trusses may preferably be formed of wood or wood products. Each transverse rail includes an upper horizontal chord 32, a lower horizontal chord 34, and webbing 38 comprising individual webbing pieces 40. In a particular embodiment the horizontal chords and webbing pieces may be formed of conventional 1 inch×2 inch (nominal) grade no. 1 or grade no. 2 lumber. Five total web pieces have been found to be sufficient. For a particular size mattress foundation, actual dimensions can vary, of course dependent upon factors such as the number of transverse rails, desired load carrying capability, thickness of the decking. Use of lumber for the transverse rails of actual dimensions of about ⅞ inch (±⅛ inch) by 1¾ inches (±¼ inch) has proven to provide a very stable base, satisfactory load carrying capability, and light weight. The height of the transverse rails is suitably about 8¾ inch and the length suitable to match the length or width of the mattress to be placed thereon less the thicknesses of the end rails. The transverse rails, as illustrated, may be preassembled utilizing glue and conventional fasteners such as staples. Dimensions herein when referred to as “about” presume a range of plus or minus 20%.

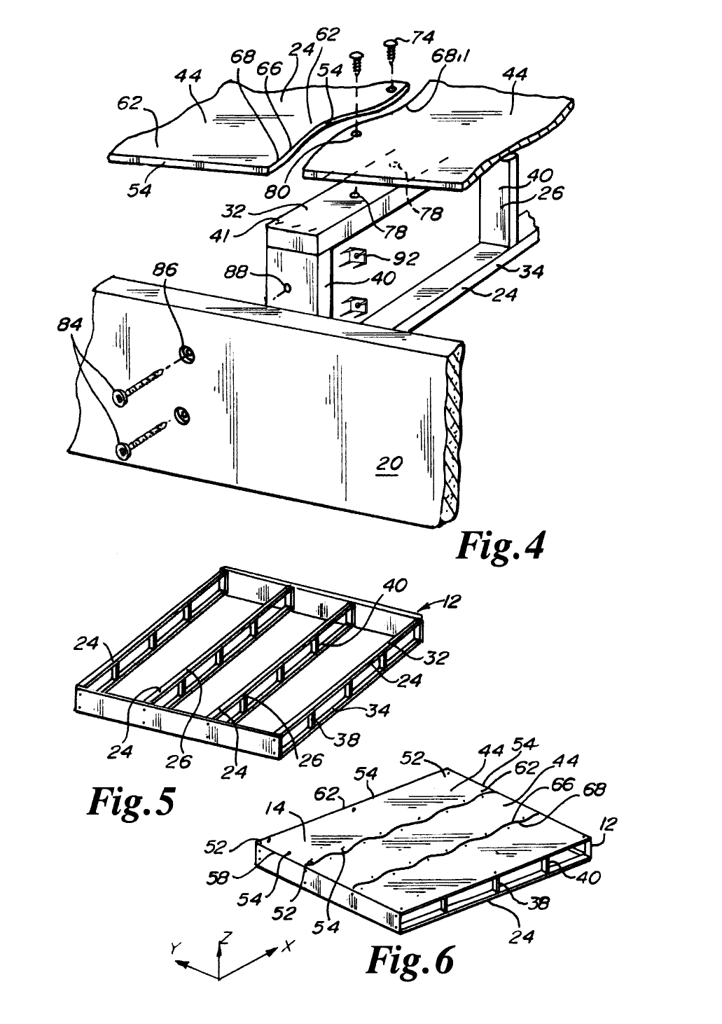

Referring to FIGS. 4, 5, 6, and 9, the end rails 20 are suitably formed of medium density fiberboard having an actual thickness of about ⅝ inch and a height of about 8¾ inches and a length that would equal the mattress width, or length. The end rails 20 could also be formed from standard lumber or in certain embodiments may also have a truss configuration. The decking 24 may preferably be formed of ¼ inch medium density fiberboard. As illustrated, a plurality of deck panels 44 each are elongate and have four corners 52 and four sides 54 with side edges 58 and edge portions 62. Each of the deck panels has at least one side 66 with a serpentine edge 68. Said edge may have a sinusoidal shape, a sawtooth shape, a square wave shape, or other complex non linear shape. As best illustrated in FIGS. 4 and 6, each such serpentine shaped edge 68 cooperates with a mirror image shaped edge 68.1 on one of the intermediate transverse rails 26. The two cooperating edges allow attachment of both edge portions to the intermediate transverse rail 26 thereunder while allowing for a minimal thickness in the x direction. As illustrated, particularly in FIG. 4, the decking may be attached with polymer push pins 74 with have an interference fit with predrilled holes 78 extending into the transverse rails and extend through oversized holes 80 in the decking. The end rails 20 are suitably and removably attached to the transverse rails by way of metal screws 84 that extend through the end rails by way of predrilled recessed holes 86 and into predrilled holes 88 in the end webbing pieces of the transverse rails with a pronged nut 92 or other suitable nut connector positioned on the inboard side of the end webbing piece. Such allows for easy assembly and disassembly.

Referring to FIGS. 4 and 6, the plastic push pins effectively attach the pre-apertured decking panels. Suitable push pins have a head and a shaft with a plurality of frustoconical locking rings on the shaft and may be manually pushed in by an assembler's hand or with a light tap from a hammer. The serpentine edges of the panels forming the decking provide a robust juncture on a narrow rail. The serpentine juncture allows for maximum panel material and maximum rail material at each fastener and for each deck panel at the juncture.

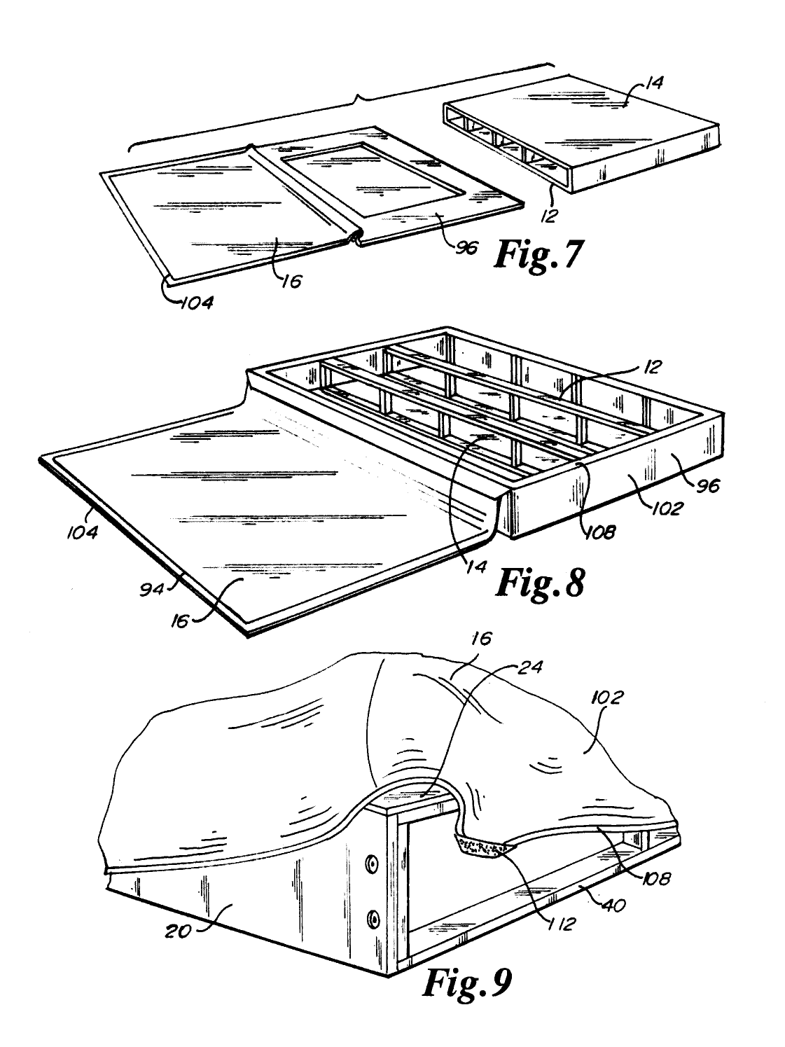

Referring to FIGS. 7, 8, and 9, the cover 16 is formed of sheet material, such as polyester or other materials and is sewn or otherwise joined to form a conforming shape to the framework. The cover is installed around the frame. A removable flap 94 may be attached to a tray shaped portion 96 with a zipper 98. A strip 102 of upholstery type fabric may extend around the perimeter of the tray shaped portion to provide an attractive exposed portion when a mattress is on the foundation. The edges 104 of the flap can attach to the edges 108 of the tray shaped portion and utilize hook and loop fasteners 112 or other fasteners to close the cover and contain the framework and decking therein.

FIG. 11 illustrates a suitable set of assembly instructions illustrating the great simplicity of such assembly.

U.S. Pat. Nos. 5,469,589; 5,564,140; 6,382,397; and 7,003,822 provide details of features and variations of construction of foundations that have aspects suitable with the inventions herein. These patents are incorporated by reference herein.

The embodiments above are intended to be illustrative and not limiting. Additional embodiments are within the claims. Any incorporation by reference of documents above is limited such that no subject matter is incorporated that is contrary to the explicit disclosure herein.

What is claimed is:

1. A foundation for a mattress comprising:
a framework with a rectangular shaped perimeter and a top surface;
a mattress supporting decking secured to the framework; and
a cover enveloping the framework and mattress supporting decking, the envelope formed of a sheet material and shaped to conform to the framework and mattress supporting decking, the cover having operable fasteners for removably opening and closing the cover;
wherein the mattress supporting decking comprises a plurality of elongate deck panels, each deck panel having four corners and four side edges, with at least one side edge of each deck panel having a serpentine shape for cooperating with another of said plurality of deck panels to form a serpentine juncture, said serpentine juncture positioned substantially on the top surface of the framework.

2. The foundation of claim 1 wherein the framework comprises two end rails and a plurality of transverse rails extending between the end rails in a parallel arrangement.

3. The foundation of claim 2 wherein the at least three transverse rails include at least two perimeter transverse rails and one intermediate transverse rail, said intermediate rail having a top surface and wherein the serpentine juncture is positioned entirely on the top surface of the at least one intermediate transverse rail.

4. The foundation of claim 3 wherein the deck panels are attached to the framework with a plurality of polymer push pins, each push pin having a head and a shaft extending therefrom with a multiplicity of retention rings on the shaft.

5. The foundation of claim 3, wherein the transverse rails are attached to the end rails by way of a plurality of metal screws extending through the end rails into metal insert nuts in the transverse rails.

6. The foundation of claim 1 wherein each of the transverse rails is of a wood truss configuration, with each truss comprising a pair of horizontal chords and a plurality of webbing pieces secured and extending there between.

7. The foundation of claim 14 wherein each of the end rails comprises a homogeneous board comprised of wood.

8. A foundation for a mattress comprising:
a wood framework with a rectangular shaped perimeter, the framework comprising a pair of end rails and a plurality of transverse rails extending between the end rails, wherein each of the transverse rails is of a wood truss configuration with a pair of horizontal chords and webbing there between, and wherein each of the end rails comprises a homogeneous board formed of one of wood and a wood product with metal screws and insert nuts securing the transverse rails to the end rails; and
a mattress supporting decking secured to the framework, the mattress supporting decking comprising a plurality of elongate panels, the elongate panels comprising a wood product; the elongate panels fastened to the framework with polymer push pins extending into predrilled holes in the framework.

9. The foundation of claim 8 wherein each panel of the plurality of elongate panels, has four corners and four side edges, at least one of the each of the four side edges of each panel having a non linear, complex configuration for interlacing with an adjacent edge of an adjacent panel, said adjacent edge having a mirror image configuration of said non linear, complex configuration.

10. The foundation of claim 8 wherein a cover comprising fabric envelops the framework and mattress supporting decking, the cover having a flap with an edge, a plurality of operable fasteners positioned on the edge.

11. A foundation for a mattress comprising:
a framework secured together with removable and reusable fasteners, the framework having a rectangular shaped perimeter;
a mattress supporting decking secured to the framework; and
a cover enveloping the framework and mattress supporting decking, the envelope formed of a flexible sheet material and shaped to conform to the framework and mattress supporting decking, the cover having fastener portions on adjacent edges of the cover for repeatedly opening and closing the cover;
wherein the mattress supporting decking comprises a plurality of elongate panels, each panel having four corners and four side edges, with at least one side edge of each panel having a serpentine shape for cooperating with another of said plurality of panels to form a serpentine juncture there between.

12. The foundation of claim 11 wherein the framework has a top surface and each of the edges with said serpentine shape is positioned over the top surface of the framework.

13. The foundation of claim 12 wherein each of the deck panels have a plurality of apertures therein and the top surface of the framework has a plurality of preexisting holes therein and wherein each of the deck panels are attached to the framework by polymer push pins extending through the holes in the deck panels and into the preexisting holes in the top surface of the framework.

14. The foundation of claim 11 wherein the framework is comprised of two end rails and a plurality of transverse rails including an intermediate transverse rail, and wherein the transverse rails are abutingly secured to the end rails by way of metal threaded fasteners extending through preexisting holes in the end rails into preexisting holes in the transverse rails and metal insert nuts in the transverse rails.

15. The foundation of claim 14 wherein each of the transverse rails is configured as a truss with two horizontal wood chords and a plurality of vertical wood webbing pieces extending between and attached to the two horizontal chords.

16. The foundation of claim 15 wherein the two horizontal wood chords and plurality of vertical wood webbing pieces are formed of 1 inch by 2 inch nominally sized lumber.

17. A method of assembling a foundation, the method comprising the steps of:
arranging a plurality of transverse rails, including an intermediate rail in a parallel alignment, each of the rails formed of one of wood and a wood product, each of the rails having opposing ends and a top surface;
attaching a pair of end rails to ends of the transverse rails thereby forming a framework with a rectangular perimeter, each of the end rails having a top surface;
attaching a plurality of elongate deck panels comprising wood or a wood product and having four corners and four side edges, each of the side edges of the elongate panels positioned entirely over at least one of a top surface of a transverse rail and a top surface of a end rail whereby there are no unsupported side edges of the deck panels.

18. The method of claim 17 wherein each of the deck panels is formed with at least one side edge with a shape that is a non linear complex shape extending between two of the four corners, the method further comprising the step of assembling each of said side edges having a non linear complex shape on a top surface of a transverse rail that is in a close cooperating relationship with a deck panel edge having a mirror image shape to the non linear complex shape.

19. The method of claim 17 wherein each of the deck panels have a plurality of holes and each of the transverse rails have a plurality of corresponding holes, and the method further comprises the step of attaching the deck panels to the framework by using a plurality of plastic push pins extending through individual holes in the plurality of deck panels into individual holes in the plurality of rails and pushing without rotation the push pins into the respective holes.

20. The method of claim 17 further comprising the step of entirely covering the framework and attached deck panels with a cover form fit to the framework and the attached deck panels by attaching at least two edges of the cover together with an elongate fastener that extends along the at least two edges, the elongate fastener comprising one of hook and loop material and a zipper.

21. A knockdown foundation comprising a plurality of rails for supporting decking including at least one intermediate rail, the at least one intermediate rail having a top surface with a width, each of the rails having a length and pair of opposing ends, a pair of end caps attachable to the ends of the plurality of rails forming a rectangular framework, the foundation further comprising a plurality of mattress supporting deck panels, the deck panels configured with at least two of the deck panels having cooperating serpentine edges whereby the cooperating serpentine edges may be put in a confronting arrangement defining a juncture over the at least one intermediate rail the juncture positioned over the top surface of the intermediate rail, the deck panels securable with fasteners to the rails.
